(19) United States
(12) Patent Application Publication
(10) Pub. No.: US 2002/0137530 A1
(43) Pub. Date: Sep. 26, 2002

(54) Cellular telephone with SMS message forwarding

(76) Inventor: Katyayini Karve, Bangalore (IN)

Correspondence Address: MOTOROLA, INC., 1303 EAST ALGONQUIN ROAD, IL01/3RD, SCHAUMBURG, IL, 60196

(21) Appl. No.: 09/801,886

(22) Filed: Mar. 8, 2001

(51) Int. Cl. H04Q 7/20; H04M 11/10

(52) U.S. Cl. 455/466; 455/461; 455/412

(57) ABSTRACT

A cellular telephone that supports SMS messaging includes a feature that allows received SMS messages to be forwarded to another number or device. The telephone includes a database memory for storing a forwarding address, a controller connected to the database memory for accessing the forwarding address, a display connected to the controller for displaying the forwarding address and a key for selecting the forwarding address and instructing the controller to forward received short messages to the selected forwarding address.

### BACKGROUND OF THE INVENTION

1. Field of the Invention

The present invention relates in general to communications devices and more particularly to communications devices that support SMS messaging.

2. Background of Related Art

Personal communication devices have gained widespread popularity and have dramatically changed the telecommunications industry. Such communications devices include a keypad for entering numbers and text and a small display screen for viewing information. To maintain popularity, these devices have been adding features, such as internal phone books, clocks, calendars, calculators, call related features, games and Short Message Service (SMS).

SMS has become increasingly popular amongst mobile phone users. SMS, as defined within the GSM digital mobile phone standard, is very popular in Europe, the Middle East, Asia, Africa and some parts of North America. The GSM Association announced that worldwide, 9 billion SMS messages were sent during August and they have predicted that for December 2000, 10 billion to 15 billion SMS messages will be sent.

SMS provides the capability to send and receive text messages to and from mobile telephones. The text can be words or numbers or an alphanumeric combination. Each short message is up to 160 characters in length when Latin alphabets are used and 70 characters in length when non-Latin alphabets such as Arabic and Chinese are used. Non-text based short messages for example, in binary format are also supported.

SMS is a store and forward service. That is, short messages are not sent directly from sender to recipient, but always via an SMS Center. Each mobile telephone network that supports SMS must have at least one messaging center to handle and manage the short messages.

Short messages can be sent and received simultaneously with GSM voice, data and fax calls because short messages travel over and above the radio channel using the signaling path. To use SMS, users need a subscription to a mobile telephone network that supports SMS and a mobile phone that supports SMS. SMS messages are usually sent between mobile phones. However, messages can also be sent to/from a fax machine, a PC or an Internet address.

Short messages can be originated in several different ways, from the mobile phone keypad itself or the keyboard on another device, such as a hand held computer connected to the mobile phone, or via software connected to a modem. However originated, all short messages are sent initially to a SMS Center. Once the SMS Center has received the short message, the communication link between the phone and the SMS center is terminated and the SMS Center routes the message to the specified recipient. The SMS Center also automatically adds the Originating Address such as the sender's mobile phone number and a timestamp to the short message. Received short messages are stored in the mobile phone's memory or in the SIM (Subscriber Identity Module) card.

Upon receipt of a new short message by a mobile phone, the mobile phone notifies the user that a message has been received, usually with a ring tone or vibration. The mobile phone usually also displays a message icon on its display. The user can then access and read the message by issuing the appropriate commands to the phone. Some phones provided by Motorola Corporation, the assignee of the present application, even have an Autoread SMS feature that allows the immediate viewing of short messages without any button presses at all. Once received, the recipient can save or delete the message as desired.

Mobile phone users routinely use SMS to communicate with each other. Typically, such person-to-person messaging is used to send a greeting, request information, arrange a meeting, or to tell someone something. Such messages are usually originated from the mobile phone keypad. When the information to be communicated is short or it would take too long to have a full conversation or someone is traveling overseas or not available to take a voice call, SMS is an ideal messaging medium. Network operators typically charge the same price to send a short message to someone in the same room as they do to someone traveling overseas with their mobile phone. Further, because short messages are proactively delivered to mobile phones that are typically carried by the user at all times, SMS is often more convenient than email.

SMS is also commonly used for notifying mobile phone users that they have new voice, fax or Internet mail messages waiting (unified messaging). Whenever a new message is dispatched into the mailbox, an alert by SMS informs the user of this fact. SMS messaging has also been used for ring tone and image downloading. SMS can also be used to deliver a wide range of information to mobile phone users from stock share prices, sports scores, weather, flight information, news headlines, lottery results, jokes to horoscopes.

In order to simplify the creation of short messages, some phone makers now provide predictive text input algorithms that anticipate which word the user is trying to generate. Predictive text input is said to significantly reduce the number of key strokes needed to input a message.

Conventional email facilities provide message forwarding. Forwarding allows a received message to be forwarded to one or more parties by the recipient. One benefit of forwarding is that it allows a received message to be sent without requiring retyping or rekeying of the message. Despite the addition of predictive text input facilities, it is still quite time consuming to type SMS messages using a phone keypad. Thus, other mechanisms that enhance SMS are still needed.

### SUMMARY OF THE INVENTION

It would be beneficial if SMS messages could be forwarded in the same or a similar manner as conventional email messages. Accordingly, in one embodiment, the present invention provides a mobile communications device that supports Short Message Service (SMS), the device including means for receiving a SMS short message and program code for forwarding the received short message from the mobile communications device to another device.

In another embodiment, the present invention provides a communications device that supports Short Message Service (SMS), the device including a database memory for storing at least one predefined forwarding address and a controller connected to the database memory for accessing the at least one predefined forwarding address. A display is connected to the controller for displaying the at least one accessed predefined forwarding address. At least one key is provided for selecting the predefined forwarding address and instructing the controller to forward received short messages to the selected predefined forwarding address.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a top plan view of a communications device incorporating the present invention;

FIG. 2 is a high level block diagram of the circuitry of the communications device of FIG. 1;

FIG. 3 is a flow diagram of a sequence of steps of a call forwarding feature in a mobile communications device in accordance with the present invention; and

FIG. 4 is another flow diagram of a sequence of steps of set up options of the call forwarding feature of FIG. 3.

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. The description sets forth sequences of steps for performing the procedures in connection with the illustrated embodiments. It is to be understood, however, that the same or equivalent functions and sequences may be accomplished by different embodiments that are intended to be encompassed within the spirit and scope of the invention. In the drawings, like numerals are used to indicate like elements throughout.

The present invention provides a software-implemented feature of a communications device, such as a mobile or cellular telephone that supports SMS, which allows the device to forward received short messages to other devices or addresses.

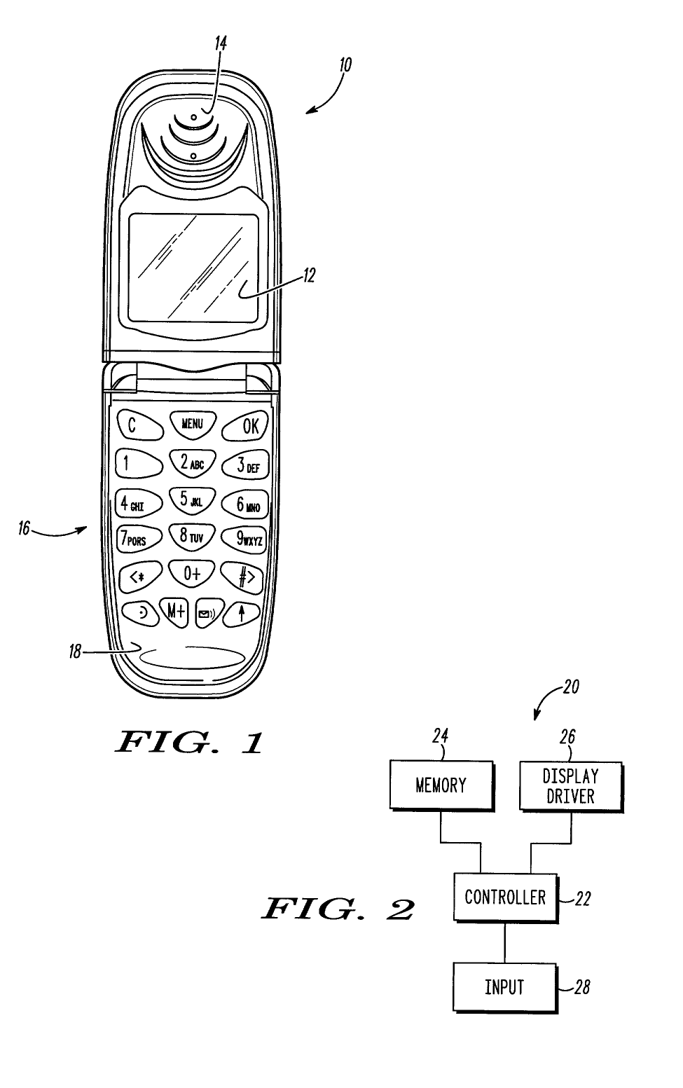

Referring now to FIG. 1, there is shown a cellular telephone 10 capable of incorporating the software feature of the present invention. The telephone 10 is preferably a digital wireless telephone, such as the Motorola Model v8088 manufactured by Motorola Corp. of Schaumburg, Ill. However, as will be apparent to those of ordinary skill in the art, the present invention is applicable to and may be embodied in other communications devices including land line telephones. The telephone 10 has output means including a visual output or display 12 and an audio output 14 and input means including a keypad 16 and a microphone 18. The keypad 16 has a plurality of keys such as numeric keys that can be used to enter alphanumeric characters and function keys, such as left and right arrows, menu, OK, etc. The keypad is thus used to enter both data and commands or instructions. The microphone 18 also is used to enter instructions and data.

Referring to FIG. 2, a high level block diagram of the circuitry 20 of the telephone 10 is shown. The circuitry 20 includes a controller 22, a memory 24, a display driver 26 and input circuitry 28. The controller 22 includes a processor, such as a digital signal processor and has one or more internal memories (not shown) containing a control program (ROM), set-up data, and a scratch pad area, as is understood by those of skill in the art. The memory 24 is connected to the controller 22 and is used to store data and/or program code. The data stored in the memory 24 can include phone book data, calendar and clock data, stored messages, etc. The memory 24 is preferably a non-volatile random access memory. Functionally, the memory 24 can include the memory space on the SIM (Subscriber Identity Module) card that is used in conjunction with the telephone 10, as is understood by those of skill in the art.

The display driver 26 is connected to the controller 22 and receives and process data from the controller 22 for displaying on the display 12. The input circuit 28 is also connected to the controller 22. The input circuit 28 receives input data (commands and data) from the keypad 16 and the microphone 18. The circuitry 20 processes the input data and commands in a manner well understood by those of skill in the art. Further, the program code required to control and operate the telephone 10 are understood by those of skill in the art.

With a conventional cell phone, a number is dialed either by entering the number directly into the telephone such as by typing in the number using the keypad, voice activation or by looking up the number in a phone book stored in the memory 24. Phone book entries can be accessed using such methods as alphabetical lookup, voice tags, or entering the memory location at which the number is stored. Typically, a phone book entry comprises the memory location, an identifier such as the person's name, and a phone number. Thus, the memory 24 is partitioned to include predefined databases in which the user can store information. According to the present invention, in addition to the well known phone book database, the memory 24 includes a space for storing received short messages and a forwarding address database. The forwarding address database stores phone numbers that may be selected by the user such that received short messages are forwarded to the selected address.

The telephone 10 is capable of receiving a SMS short message, also known as a Protocol Data Unit (PDU). A short message includes two parts, header information and short message text, which is also referred to as the user data. The header parameters include the address of the SMS Center to which the short message is to be sent, a Destination Address field denoting the final recipient of the short message, and the Originating Address, which is the address of the sender of the short message. The short message is sent from a mobile telephone or other device to an SMS Center. The SMS center looks at the header information, adds some additional header information, and then tries to send the user data to the recipient or destination address. The format of short messages, sending and receiving of short messages, and the operations of SMS centers are well known to those of skill in the art.

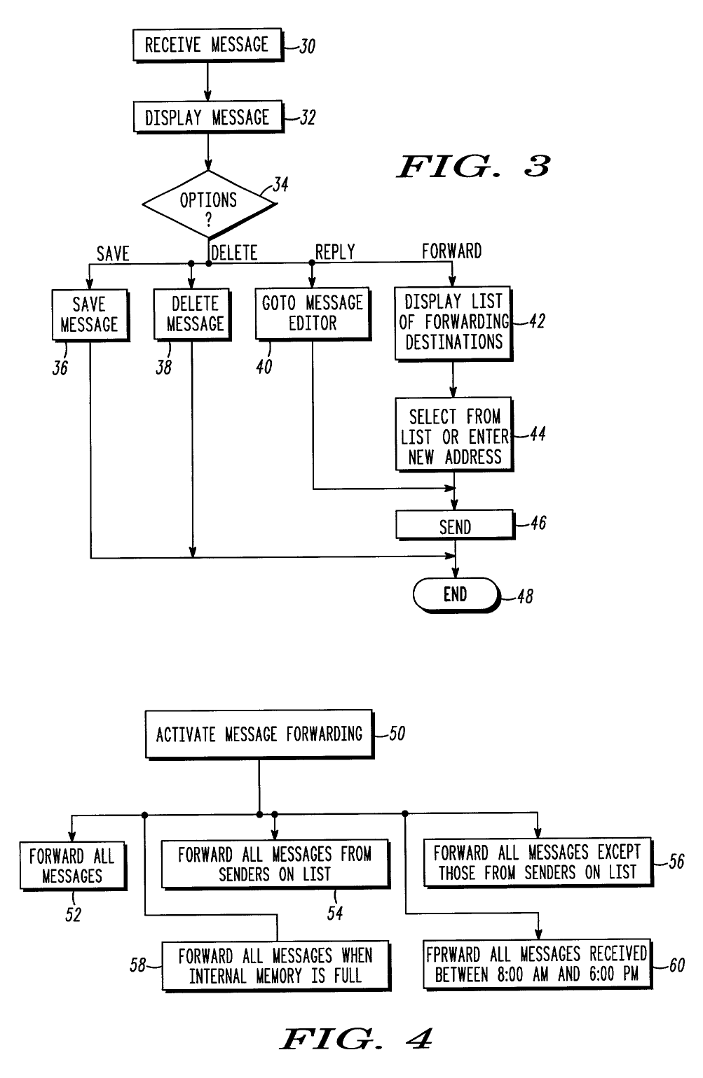

Referring now to FIG. 3, the telephone 10 includes program code for forwarding a received short message from the telephone 10 to another device or telephone. FIG. 3 is a flow diagram of a sequence of steps of such a call forwarding feature in accordance with the present invention.

The sequence of steps begins with the telephone 10 receiving a short message as indicated at 30. Once a short message is received, the message can be immediately displayed on the screen 12 or an icon indicating receipt of the message can be displayed or otherwise indicated to the user. In either case, the message is stored in the memory 24. When the user desires to read the message, the user issues the appropriate commands as understood by those of ordinary skill in the art, until the message is displayed on the screen, step 32. At step 34, the program code of the present invention offers a plurality of options to the user. A first option, step 36, is to save the message, in which case the message is saved in the memory 24. Once the message is saved, the message forwarding routine proceeds to an end step 48. A second option, step 38, is to delete the message, in which case the message is not saved to the memory 24. Like the save message step 36, the delete message step 38 is proceeded by the end step 48.

The user may also choose to edit the message, in which case the program executes step 40. The message editor allows the user to edit the text of the message. As previously discussed, message editors are well known, with some message editors employing predictive text input. After the user finishes editing the message text, the user is offered the option to send the edited message at step 46. By inputting the proper commands, such as entering a destination address or phone number and issuing a send command, the edited message is sent via an SMS center to the destination address. Once the message is sent, step 46, the program code proceeds to the end step 48.

The save, delete and edit message options illustrated in steps 36, 38, 40 are understood by those of skill in the art. However, in accordance with the present invention, the program code also offers an option to forward the received message at step 42. At step 42, a list of forwarding addresses is displayed on the display 12. The list includes phone numbers previously added to the list by the user. The user may scroll through the list and at step 44 select one or more of the numbers. Step 44 also allows the user to add one or more new numbers to the list. After the user has selected or specified the phone numbers to which the message is to be forwarded, step 46 is executed. At step 46, the short message is sent via the SMS center to the selected destinations. In order to forward the message to multiple destinations, in the presently preferred embodiment, the message is sent to the SMS center multiple times, once for each destination address. Thus, the program code directs the short message to be forwarded to the other device using the selected forwarding address.

However, as will be understood by those of ordinary skill in the art, with the appropriate programming at the SMS center or by allowing the user to define forwarding address lists stored at the SMS center, it is possible to send the message once to the SMS center, with the header portion of the message identifying a pointer to a multiple destination address stored in a memory at the SMS center.

Referring now to FIG. 4, a flow diagram of a sequence of steps of set up options of the call forwarding feature is shown. The call forwarding set up options preferably are accessed via selecting an option from a main menu. Once the call forwarding set up option is selected, the telephone 10 program code proceeds to step 50, which is the step for activating automatic message forwarding. That is, when automatic message forwarding is activated, messages received by the telephone 10 are forwarded in accordance with the selected automatic forwarding option described below.

A first option, step 52, is to automatically forward all messages to a predefined number or numbers. In step 52, the user defines the number or numbers to which all received short messages are to be forwarded. A second option, step 54, is to forward all messages received from one or more predetermined senders, as defined on a list, to one or more predefined numbers. At step 54, the user is prompted to enter the predetermined sender addresses (phone numbers) and subsequently, to enter the forwarding number(s). As an alternative to step 54, at step 56, the user can select to forward all messages except for those messages received from one or more predetermined senders, as defined on a list, to one or more predefined numbers. The option at step 56 thus allows the user to receive important messages and forward messages from senders not deemed to be as important or urgent. Similar to step 54, at step 56, the user is prompted to enter the predetermined sender addresses (phone numbers) and subsequently, to enter the forwarding number(s).

Yet another option, at step 58, is to forward all messages to a predetermined address when the portion of the telephone memory 24 used for storing short messages is full. Preferably, an icon or message is displayed on the screen 12 informing the user that the short message memory is full and that messages are being forwarded.

A further option, at step 60, allows the user to define time periods during which received short messages are automatically forwarded to a predefined number(s). At step 60, the user is prompted to enter the forwarding numbers and the time period when received messages are to be forwarded.

The description of the preferred embodiment of the present invention has been presented for purposes of illustration and description, but is not intended to be exhaustive or to limit the invention to the form disclosed. It will be appreciated by those skilled in the art that changes could be made to the embodiment described above without departing from the broad inventive concept thereof. For example, short messages could be forwarded with or without saving the short message in a memory resident in the mobile phone and the short messages could be forwarded with or without displaying the message in the mobile phone. It is understood, therefore, that this invention is not limited to the particular embodiment disclosed, but covers modifications within the spirit and scope of the present invention as defined by the appended claims.

1. A mobile communications device that supports Short Message Service (SMS), the device comprising:
means for receiving a SMS short message; and
program code for forwarding the received short message from the mobile communications device to another device.

2. The communications device of claim 1, wherein the program code directs the short message to be forwarded to the other device via a predefined forwarding address.

3. The communications device of claim 2, wherein the program code directs only short messages received from a predetermined originating address to be forwarded to the predefined forwarding address.

4. The communications device of claim 2, wherein the program code directs only short messages received from an address other than one or more predetermined originating addresses to be forwarded to the predefined forwarding address.

5. The communications device of claim 2, wherein the program code directs only short messages received during a predetermined time period to be forwarded to the predefined destination address.

6. The communications device of claim 2, further comprising a memory for storing received SMS messages, wherein the program code directs only short messages received after the memory is filled to be forwarded to the predefined forwarding address.

7. A communications device that supports Short Message Service (SMS), the device comprising:
a database memory for storing at least one predefined forwarding address;
a controller connected to the database memory for accessing the at least one predefined forwarding address;
a display connected to the controller for displaying the at least one accessed predefined forwarding address; and
at least one key for selecting the predefined forwarding address and instructing the controller to forward received short messages to the selected predefined forwarding address.

8. The communications device of claim 7, wherein the controller directs only short messages received from a predetermined originating address to be forwarded to the predefined forwarding address.

9. The communications device of claim 7, wherein the controller directs only short messages received from an address other than one or more predetermined originating addresses to be forwarded to the predefined forwarding address.

10. The communications device of claim 7, wherein the controller directs only short messages received during a predetermined time period to be forwarded to the predefined forwarding address.

11. The communications device of claim 7, further comprising a memory space for storing received SMS messages, wherein the controller directs only short messages received after the memory space is filled to be forwarded to the predefined forwarding address.
